(19) United States
(12) Patent Application Publication
(10) Pub. No.: US 2025/0076628 A1
(43) Pub. Date: Mar. 6, 2025

(54) ILLUMINATION UNIT FOR AN OPTICAL MICROSCOPE AND METHOD FOR THE USE THEREOF

(71) Applicant: Carl Zeiss Microscopy GmbH, Jena (DE)

(72) Inventors: Thomas MILDE, Nausnitz (DE); Artur DEGEN, Moscow (RU); Jana LEPSCHI, Jena (DE)

(21) Appl. No.: 18/804,614

(22) Filed: Aug. 14, 2024

(30) Foreign Application Priority Data
Aug. 28, 2023 (DE) DE102023123036.0

(51) Int. Cl. G02B 21/08; G02B 21/36

(52) U.S. Cl. CPC G02B 21/08; G02B 21/36

(57) ABSTRACT

The present invention relates first to an illumination unit for an optical microscope. The illumination unit serves to illuminate a sample to be examined by microscopy using the microscope and comprises a multiplicity of individual light sources for this purpose. The illumination unit also comprises a multiplicity of light mixing elements, each having the shape of a solid or hollow pyramidal frustum with a bottom base, a top base, a lateral face and an axis. The individual light sources are each arranged above the top bases of the light mixing elements. The bottom bases of the light mixing elements together form a light exit surface of the illumination unit. The invention further relates to an optical microscope having the illumination unit according to the invention and to a method for using the microscope according to the invention.

### BACKGROUND OF THE INVENTION

The present invention relates first to an illumination unit for an optical microscope. The illumination unit serves to illuminate a sample to be examined by microscopy using the microscope and comprises a multiplicity of individual light sources for this purpose. The invention further relates to an optical microscope having the illumination unit according to the invention and to a method for using the microscope according to the invention.

In digital microscopy, the provision of different types of illumination is conventional in quality assurance and quality control applications. Typical types of illumination are ring light, coaxial reflected light and transmitted light. Since most examination objects are not transparent, the transmitted light performs the function of making objects visible as shadows against a bright background in order to be able to detect and measure external contours. A ring light usually fulfills the task of providing on the sample the most diffuse illumination possible from different solid angles. In many applications, said ring light is generated outside the observation aperture by LEDs arranged in a ring and used with collector devices for efficient illumination of the sample. In non-telecentric observation, the light sources of the ring light might on occasion be directly recognizable as bright reflections when viewing a flat, reflective sample. In the case of telecentric observation, this effect does not occur with such samples, and dark-field illumination occurs. The ring light can be distributed uniformly over the sample using collimation or homogenization elements, and so no inhomogeneities can be detected anymore. Ring light arrangements are designed modularly as an attachment to the objective with additional wiring or in a manner securely integrated into the objective or microscope base body.

For non-flat samples, the ring light sources may also lead to direct reflections that are imaged on the camera of the digital microscope.

DE 10 2015 208 080 A1 relates to a reflection correction method for correcting digital microscopic images. An object is illuminated with at least two illumination patterns. An illumination pattern image of the object is created for each illumination pattern. At least one partial reflection image is calculated in each case by a combination of two corresponding illumination pattern images. A reflection-corrected image of the object is calculated by combining at least one illumination pattern image and at least one partial reflection image. Each illumination pattern has at least one active illumination source. The illumination patterns differ from one another. In this context, the term illumination pattern in particular also includes those illumination arrangements in which the sample is illuminated homogeneously, and the pattern is formed only due to selected angles of incidence; for example, by illumination from only one cardinal direction.

DE 10 2015 208 087 A1 and U.S. Pat. No. 10,620,417 B2 disclose a method for generating a reflection-reduced contrast from microscopic images for reading height progression information of an object condition. An object is illuminated by means of an illumination sequence. An illumination image of the object is created for each illumination of the object of the illumination sequence. A reflection-corrected illumination image is determined for each illumination image. Two reflection-corrected illumination images that are adjacent with respect to the first axis are overlaid in each case in order to form a first whole axis image of the first axis. Two reflection-corrected illumination images that are adjacent with respect to the second axis are overlaid in each case in order to form a second whole axis image of the second axis. A first color progression image is created on the basis of the first whole axis image. A second color progression image is created on the basis of the second whole axis image. The first color progression image and the second color progression image are transformed into a color space. A contrast image is generated on the basis of the first color progression image and the second color progression image transformed in the color space.

DE 10 2016 108 079 A1 has disclosed an optical device having a sample holder configured to fix an object in the beam path of the optical device. An illumination module of the optical device comprises a plurality of light sources and is configured to illuminate the object from a plurality of illumination directions by operating the light sources. Each illumination direction has an assigned luminous field. The optical device also comprises a filter arranged between the illumination module and the sample holder and configured to expand the associated luminous field for each illumination direction. This is intended to reduce artifacts due to contaminants in angle-selective illumination.

The aforementioned documents describe how a result image in which the reflections are reduced or even completely eliminated can be calculated using sequential image acquisition and a corresponding sequential activation of parts of the ring illumination. Likewise, digital contrasts can be achieved for the examination of the object by activating only parts of the ring light for individual images or, as in the case of reflection correction, by using an algorithm to illuminate a plurality of images with individual light patterns and combining these images by calculation to form a result image.

The prior art has disclosed the practice of reflecting coaxial reflected light into the beam path downstream of the objective, preferably into an infinity space. The aim is to achieve the most homogeneous angular distribution possible, because this translates into homogeneous field illumination via the objective. In digital microscopy, it is common for an optical zoom to allow various magnifications and numerical apertures for observing the object. Typically, the coaxial reflected light is reflected-in between this zoom and the objective, as this is usually the location where the objective interface is also located and thus usually also an infinity space. Without the use of an illumination zoom, the reflected-in coaxial reflected light must offer both all angles for the maximum field and the diameter for the maximum numerical aperture. For this reason, an elaborate lens arrangement is often chosen, in which a luminous field stop for the illumination beam path limits the angles in the case of a full aperture. Alternatively, the coaxial reflected light illumination is only reflected-in downstream of the zoom but this is disadvantageous in that each lens, which must be passed by the coaxial reflected light on the way to the object, potentially generates internal reflections or reduces the light yield. The latter is particularly true in the case of a polarization-based anti-reflection device. In the case of non-Köhler illumination, the possibility of controlling the spatial distribution of the illumination in the objective pupil is also severely limited.

### SUMMARY OF THE INVENTION

Using the prior art as a starting point, the problem addressed by the present invention is that of how to be able to illuminate a sample for a microscopic examination flexibly with different types of illumination without having to accept disadvantages such as undesired reflections.

The stated problem is solved by an illumination unit as claimed in the attached claim 1, by a microscope as claimed in the attached alternative independent claim 8 and by a method as claimed in the attached alternative independent claim 10.

The illumination unit according to the invention forms a component of an optical microscope and serves for illuminating a sample to be examined by microscopy using the microscope. The illumination unit may form an integral part of the microscope or be designed as an interchangeable module for the microscope. The illumination unit emits light that is incident on the sample such that the sample can be imaged in magnified fashion using the microscope.

The illumination unit comprises a multiplicity of individual light sources for emitting light to illuminate the sample. The individual light sources are preferably arranged in a distributed manner in a plane. The individual light sources are preferably arranged in a distributed manner within an area which preferably has a circular shape. The individual light sources are preferably arranged in a matrix-like manner. The adjacent individual light sources are preferably spaced apart equidistantly.

The illumination unit also comprises a multiplicity of light mixing elements, each for mixing the light emitted by one of the individual light sources. The light mixing elements each have the form of a solid or hollow pyramidal frustum with a bottom base, with a top base, with a lateral face and with an axis. In the case of a hollow pyramidal frustum shape, the top base and the bottom base each have the shape of a polygon with an inner polygonal cutout, wherein the polygon and the polygonal cutout are preferably regular, geometrically similar and concentric, and wherein the polygon is preferably only slightly larger than the polygonal cutout. Within the solid or hollow pyramidal frustum shape, the light of the respective individual light source is mixed in each case. The individual light sources are each arranged above the top bases of the light mixing elements. Insofar as the top bases each have an inner cutout, the individual light sources are preferably each arranged above the inner cutout of the respective top base. The individual light sources are preferably each arranged as close as possible above the top bases of the light mixing elements in order to input couple as much light as possible from the respective individual light source into the light mixing element. The individual light sources are preferably each seated on the top bases of the light mixing elements. By preference, exactly one of the individual light sources is in each case arranged above the top base of exactly one of the light mixing elements. By preference, exactly one of the individual light sources is in each case seated on the top base of exactly one of the light mixing elements. The bottom bases of the light mixing elements together form a light exit surface of the illumination unit. At the light exit surface, the light of the individual light sources mixed by the light mixing elements exits and leaves the illumination unit in order to be able to be used to illuminate the sample. The light exit surface is preferably flat. The bottom bases of the light mixing elements preferably represent facets, which are arranged in tessellated fashion in order to form the light exit surface together. The facets, which together form the closed light exit surface, are alternatively preferably arranged at a same position, for example on a common transparent base plate, after having also been scaled by a factor of less than one. This can bring about advantages in the joint production of the light mixing elements as a monolithic component, for example within the scope of an injection molding method using a transparent plastic. This requires a casting tool without dividing walls that come together at a point.

The light of the respective individual light source is reflected multiple times in the respective light mixing element, and so the angle between individual light beams of the light emitted by the individual light source and the axis becomes smaller with each reflection, whereby a homogeneous distribution of the light emitted from the light exit surface is achieved. Any reflection of light on a reflective surface will result in energy loss. An exception is total-internal reflection. The surfaces of the light mixing elements are preferably smooth, i.e. the surfaces have such a low roughness that technically relevant scattering no longer occurs. This would be contrary to the aim of light-shaping and generate uncontrollable light directions, and redistribute light energy therein. Insofar as the light mixing elements each have the shape of a hollow pyramidal frustum, this leads to an ideal entry and ideal exit. The inner walls of the hollow light mixing elements are preferably smooth in each case and have a reflective coating.

A particular advantage of the illumination unit according to the invention is that it is suitable for the flexible generation of different types of illumination and forms of illumination. By selecting the individual light sources to be operated in each case, the diameter of the luminous component of the light exit surface can be changed, for example. Different shapes, such as a ring light for example, can also be produced. A coaxial reflected light can be generated. It is possible to flexibly switch between different types of illumination. The aforementioned reflection reduction and digital contrast methods are particularly conducive to the activation of the individual light sources in an azimuthal selection around the center of the light exit surface, for example in propeller-like segments or in hemispheres. Within such segments it is also possible to select radially between bright field and dark field. Limiting the azimuthal segments to individual radial rings can also be used to generate digital contrasts. The illumination can be implemented with or without a central individual light source.

A further particular advantage of the illumination unit according to the invention is that it can always be operated in such a way that the light emitted by the operated individual light sources is deflected by the light mixing elements in such a way that each of the operated individual light sources emits only in directions received by an objective of the microscope in the respective configuration and setting of the microscope. This ensures a high efficiency of the illumination unit and prevents interfering reflections, for example at lens edges in the interior of the objective.

In preferred embodiments, the light mixing elements are each formed by a light mixing rod in the form of a solid pyramidal frustum. In alternative preferred embodiments, the light mixing elements are each formed by a hollow integrator in the form of a hollow pyramidal frustum.

In preferred embodiments, the light mixing elements have the same design. The light mixing elements preferably have the same shape. Likewise, the individual light sources preferably have the same design. The individual light sources preferably have the same shape and the same properties in relation to the generation of light.

The pyramidal frustums forming the shape of the light mixing elements are preferably right pyramidal frustums, and so the bottom bases and the top bases are each aligned perpendicular to the respective axis. The center of the bottom base and the center of the top base preferably lie on the axis of the respective pyramidal frustum.

In preferred embodiments, the axes of the pyramidal frustums forming the shape of the light mixing elements are arranged in parallel. The axes are preferably spaced apart equidistantly from one another.

In preferred embodiments, the bottom bases of the pyramidal frustum-shaped light mixing elements each have the external shape of a convex polygon, which is suitable for gap-free tessellation of the bottom bases. In preferred embodiments, the bottom bases of the pyramidal frustum-shaped light mixing elements each have the external shape of a triangle, a square or a regular polygon. Particularly preferably, the bottom bases of the pyramidal frustum-shaped light mixing elements each have the external shape of an equilateral triangle, a square or a regular hexagon. The top bases preferably each have the same external shape as the bottom bases, but they are smaller. In principle, however, the light mixing elements can also have adaptation sections if the external shape of the bottom bases differs from the shape of the top bases.

In preferred embodiments, the bottom bases of the pyramidal frustum-shaped light mixing elements completely fill the light exit surface of the illumination unit. This allows the light from the individual light sources to emerge homogeneously from the entire light exit surface. For this purpose, the same bottom bases each have a shape suitable for completely filling a surface by being joined together. For example, this holds true for the shape of a regular hexagon, and so the light exit surface is filled like a honeycomb by the bottom bases of the light mixing elements. For manufacturing reasons, it may be advantageous that connecting pieces are formed between the bottom bases.

In preferred embodiments, the pyramidal frustum-shaped light mixing elements each have a termination region, in which the lateral faces are perpendicular to the axis, at their bottom bases. In this respect, the termination regions represent a short extension of the pyramidal frustum shape in which the light mixing elements are no longer conical; this facilitates the assembly of the light mixing elements for assembling the illumination unit. The illumination unit preferably comprises a frame in which the pyramidal frustum-shaped light mixing elements are clamped at their termination regions and align during assembly and thus completely fill the light exit surface. In alternative preferred embodiments, the pyramidal frustum-shaped light mixing elements are fastened to a base plate with their bottom bases, as is the result of a monolithic production method, for example.

In preferred embodiments, at least three of the bottom bases of the light mixing elements come into contact at one point on a central axis of the light exit surface. Thus, there is no single central light scale or single central individual light source. The central axis of the light exit surface is provided to be located on the optical axis of the microscope such that there is accordingly no single central light scale or single central individual light source on the optical axis. As a result, no central direct reflection is created at lens vertices along the optical axis. This embodiment renders realizable an integrated microscope illumination with bright-field reflected light segments that requires no further anti-reflection measures, such as a polarizer or an analyzer, for example. In alternative preferred embodiments, the bottom base of exactly one of the light mixing elements is situated centrally on a central axis of the light exit surface. Thus, there is a single central light scale or a single central individual light source.

The light mixing elements preferably consist of a glass, a quartz glass or a transparent plastic. The lateral faces may have inwardly reflective surfaces.

Each individual light source is preferably formed by an electrical light source. Each individual light source is preferably formed by an LED or another light-emitting semiconductor. However, fiber ends of an illumination fiber can also be placed against the top bases of the light mixing elements. In further preferred embodiments, the light emittable by the individual light sources can be modified in terms of its spectral properties, for which each individual light source is formed by a 4-color LED, for example.

In preferred embodiments, the individual light sources are arranged as closely as possible on the solid or cutout top bases of the light mixing elements. Accordingly, each individual light source is arranged with an air gap of preferably less than 1 mm and further preferably less than 100 μm from the top base of the respective light mixing element.

In preferred embodiments, the individual light sources each have a flat expanse with which the individual light sources are arranged on the solid or cutout top bases of the light mixing elements and cover the top bases in each case. Thus, the individual light sources can emit their light completely into the totality of top bases of the light mixing elements. Insofar as the individual light sources protrude beyond the top bases of the light mixing elements on at least one side, the illumination unit preferably comprises apertures which are arranged in each case above the top bases of the light mixing elements and prevent an emission of light into a space between the light mixing elements.

In preferred embodiments, the illumination unit comprises at least 20 of the solid or hollow light mixing elements. In further preferred embodiments, the illumination unit comprises at least 40 of the solid or hollow light mixing elements. In further preferred embodiments, the illumination unit comprises at least 50 of the solid or hollow light mixing elements.

In preferred embodiments, the bottom bases of the light mixing elements are uniformly distributed around a central axis of the light exit surface in the light exit surface. The bottom bases of the light mixing elements are preferably enveloped by a circle which is located on the light exit surface and whose center is on the central axis of the light exit surface.

The bottom bases of the light mixing elements each have a maximum extent of preferably between 2 mm and 10 mm. The top bases of the light mixing elements each have a maximum extent of preferably between 0.5 mm and 3 mm. The light mixing elements each have a maximum height of preferably between 10 mm and 100 mm. The height is preferably at least ten times larger than the maximum extent of the bottom base. Since the light mixing elements are preferably much higher than they are wide, and hence the deviation of the cross section from the circular shape becomes less important, their shape can be described as a cone to a first approximation.

The optical microscope according to the invention serves to examine a sample by microscopy. For this purpose, the microscope comprises an imaging optical unit for imaging the sample along a microscope beam path. The imaging optical unit preferably comprises at least one objective and preferably also a zoom optical unit and a tube lens. Furthermore, the microscope comprises the illumination unit according to the invention for illuminating the sample. The illumination unit is preferably input coupled into the microscope beam path optically, for example by virtue of the light emerging from the light exit surface of the illumination unit being reflected into the microscope beam path.

In preferred embodiments, the microscope comprises a beam splitter, which is preferably arranged in the vicinity of an objective pupil of the imaging optical unit and which divides the microscope beam path into an observation component beam path and an illumination component beam path. The beam splitter is preferably arranged just upstream or downstream of the objective pupil of the imaging optical unit. The light exit surface of the illumination unit is arranged in the illumination component beam path. The sample is observed via the observation component beam path. Either the observation component beam path or the illumination component beam path can lie on the axis of the microscope beam path. From the beam splitter, the illumination component beam path and the observation component beam path preferably run together along the optical axis of the imaging optical unit. However, the illumination component beam path may be configured to have no or only a partial or complete overlap with the observation component beam path. The illumination unit is preferably located in an infinity space.

The imaging optical unit preferably comprises a stereo objective or an objective which has a larger pupil than is required for examining the sample by microscopy. This allows an internal dark field to be realized. Alternatively, the method described below is preferably used to record a plurality of images under different illumination conditions. The plurality of images are then combined by computation to create a high-contrast image that renders visible similar properties of the sample as dark-field illumination.

The microscope preferably comprises one of the described preferred embodiments of the illumination unit according to the invention. Incidentally, the microscope preferably also comprises features which are specified in the context of the illumination unit according to the invention and the preferred embodiments thereof.

The method according to the invention serves to use the optical microscope according to the invention. In one step of the method, a selection of the individual light sources are determined according to a specified characteristic of illumination of the sample to be achieved by the illumination unit. The selection of the individual light sources preferably represents a proper subset such that the selection does not comprise all of the individual light sources. The characteristic of the illumination is determined by the type of illumination, for example reflected light illumination or ring light illumination, and/or by dimensions, for example a diameter, and/or by photometric quantities, for example the illuminance, and/or by spectral properties. In a further step, the selected individual light sources are operated such that they shine and illuminate the sample according to the specified characteristic of the illumination.

The method according to the invention uses the advantages of the illumination unit according to the invention. The sample can be illuminated flexibly with different types of illumination and forms of illumination.

In a preferred embodiment, the selection of the individual light sources comprises those of the individual light sources whose assigned light mixing elements with their bottom bases in a radial direction are located in an observation pupil of the microscope. The radial direction is related to an optical axis of the imaging optical unit. In an axial direction, i.e. in the direction of the optical axis of the imaging optical unit, a possible distance between the bottom bases of the light mixing elements and the observation pupil can be ignored in this embodiment. In this embodiment, the sample is illuminated with a coaxial bright-field reflected light illumination.

In a further preferred embodiment, the selection of the individual light sources comprises those of the individual light sources whose assigned light mixing elements with their bottom bases in the radial direction are located outside of an observation pupil of the microscope. As a result, the sample is illuminated with a coaxial dark-field illumination.

In a further preferred embodiment, the selection of the individual light sources comprises those of the individual light sources whose assigned light mixing elements with their bottom bases are situated in an off-centered partial segment of the light exit surface. As a result, a selected portion of the sample can be illuminated in a targeted fashion.

In a preferred embodiment, the steps of determining a selection of the individual light sources and operating the selected individual light sources are repeated to illuminate the sample according to a further specified characteristic of the illumination. This makes use of the advantage of the invention to be able to switch quickly and efficiently between different types of illumination and forms of illumination.

In a further preferred embodiment, the selection of the individual light sources also comprises specifics regarding their operation, for instance reduced brightness, a temporal behavior or spectral properties of their emission. The individual light sources are then operated according to the selected specifics.

The method is preferably applied to use preferred embodiments of the microscope according to the invention.

### BRIEF DESCRIPTION OF THE DRAWINGS

Further details and developments of the invention will become apparent from the following description of preferred embodiments of the invention, with reference being made to the drawing. In the figures:

FIG. 1: shows a perspective illustration of a preferred embodiment of an illumination unit according to the invention;

FIG. 2: shows the illumination unit shown in FIG. 1 in a front view;

FIG. 3: shows a light mixing rod of the illumination unit shown in FIG. 1 on its own;

FIG. 4: shows the light mixing rod shown in FIG. 3 in a front view;

FIG. 5: shows a schematic illustration of a first preferred embodiment of a microscope according to the invention;

FIG. 6: shows a schematic illustration of a second preferred embodiment of the microscope according to the invention; and

FIG. 7: shows a further preferred embodiment of the illumination unit according to the invention.

### DETAILED DESCRIPTION OF THE INVENTION

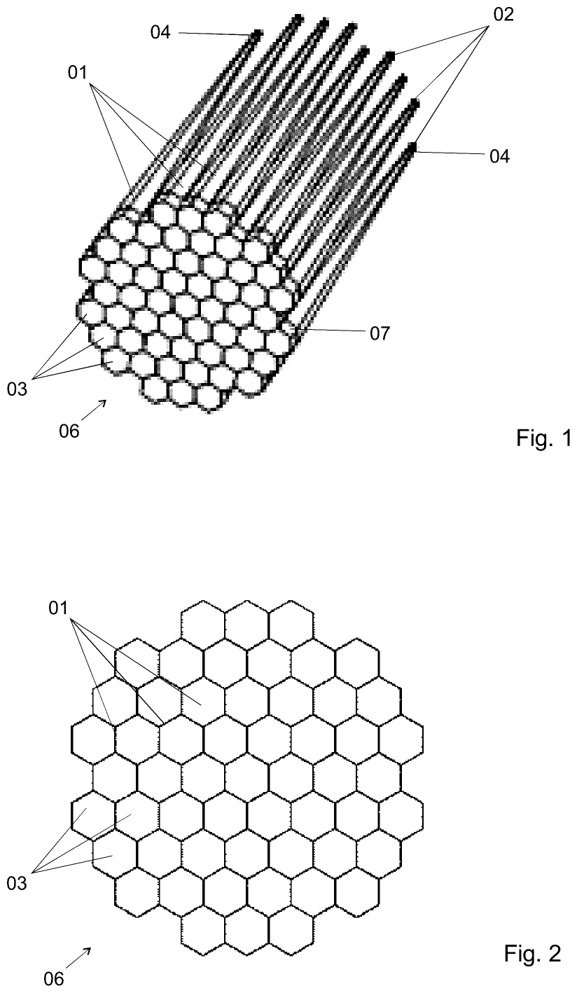

FIG. 1 shows a perspective illustration of a preferred embodiment of an illumination unit according to the invention. The illumination unit comprises a multiplicity of identical light mixing rods 01, which serve to align and homogenize light from a multiplicity of LEDs 02. Each light mixing rod 01 has the shape of a right pyramidal frustum with a bottom base 03 and a top base 04. The bottom bases 03 and the top bases 04 each have the shape of a regular hexagon.

The light mixing rods 01 are arranged parallel and flush to one another, and so their bottom bases 03 form, in tessellated fashion, a flat surface that represents a light exit surface 06 of the illumination unit. The pyramidal frustum-shaped light mixing rods 01 have at their bottom bases 03 a short termination region 07 each with parallel lateral faces, whereby the tessellation-like joining of the light mixing rods 01 is facilitated. The light mixing rods 01 are arranged such that their bottom bases 03 form the light exit surface 06 with a shape which is enveloped by a circle, and so the light exit surface 06 has, approximated to the best possible extent, a circular shape.

FIG. 2 shows the illumination unit shown in FIG. 1 in a front view. In this front view, it is possible to identify the light exit surface 06 with an approximately circular shape formed by the bottom bases 03 of the light mixing rods 01 in tessellated fashion. The bottom bases 03 of the light mixing rods 01 completely fill the light exit surface 06.

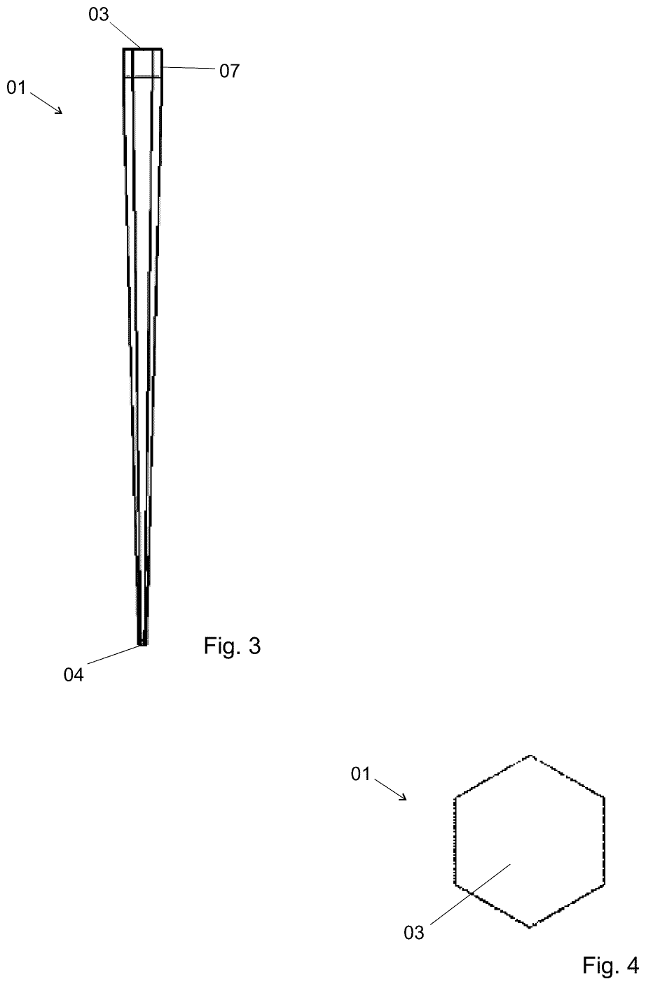

FIG. 3 shows a lateral view of one of the light mixing rods 01 shown in FIG. 1 on its own. In this view, it is possible to identify the extent of the light mixing rods 01 in particular.

FIG. 4 shows the light mixing rod 01 shown in FIG. 3 in a front view. In particular, it is possible to identify the regular hexagonal shape of the bottom base 03.

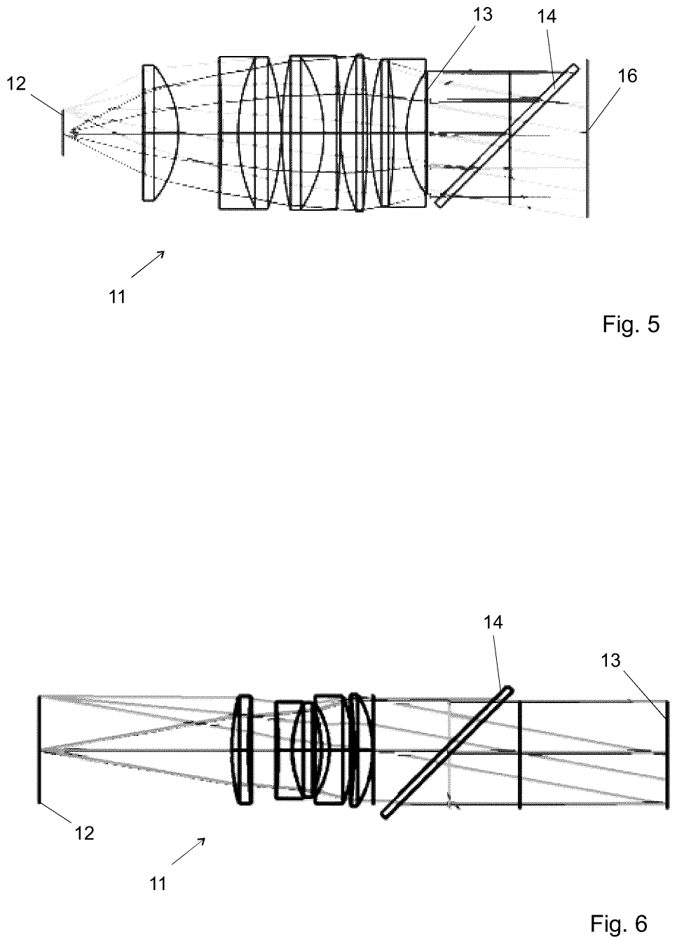

FIG. 5 shows a schematic illustration of a first preferred embodiment of a microscope according to the invention. The microscope comprises an imaging optical unit 11 for optical imaging of a sample 12. By way of example, the object field diameter is 18 mm. A beam splitter 14 for output coupling an observation component beam path (not shown) is located in the vicinity of an objective pupil 13, while an illumination component beam path (not shown) leads to an infinity space, where an illumination input coupling plane 16 is located, the light exit surface 06 (shown in FIG. 1) of the illumination unit (shown in FIG. 1) being arranged in said plane. Alternatively, the illumination component beam path (not shown) can be input coupled using the beam splitter 14. Since the beam splitter 14 is arranged in the vicinity of the objective pupil 13, the light from the illumination unit (shown in FIG. 1) is reflected into the microscope beam path in the vicinity of the objective pupil 13.

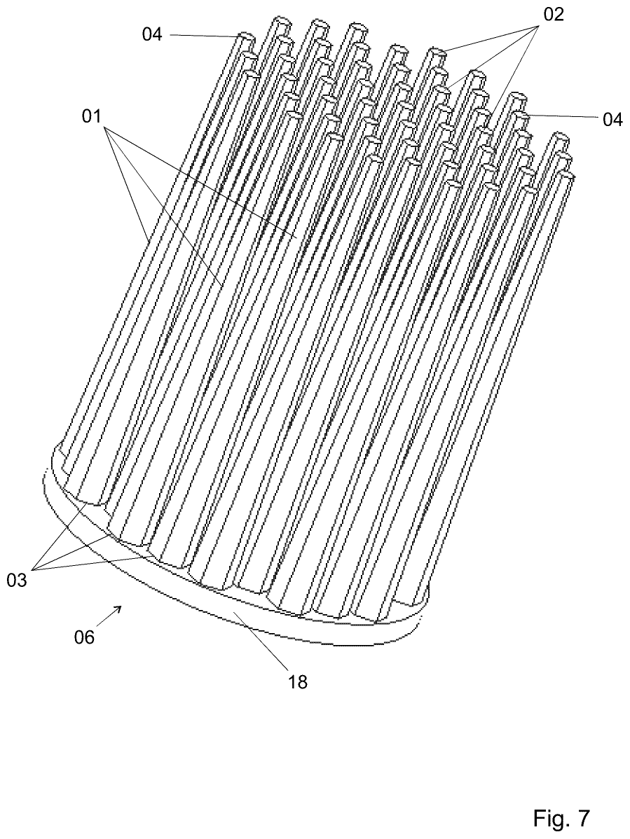

FIG. 6 shows a schematic illustration of a second preferred embodiment of the microscope according to the invention. This second embodiment initially resembles the embodiment shown in FIG. 5. In contrast with the first embodiment, the beam splitter 14 is located between the objective pupil 13 and the imaging optical unit 11. By way of example, the object field diameter is 44 mm here. The illumination component beam path (not shown) is input coupled using the beam splitter 14.

Preferably, different objectives (not shown) are assigned to the microscope. When the object distance is adjusted, the objective pupil 13 is usually found at completely different positions in the infinity space. Therefore, the light exit surface 06 (shown in FIG. 1) of the illumination unit (shown in FIG. 1) is preferably positioned at a central position between the participating objective pupils 13. This optimizes the illumination of the sample 12 in terms of field, homogeneity and reflection behavior in the imaging optical unit 11.

An observation pupil (not shown) is formed in the observation component beam path (not shown) and can also be variable along the optical axis by way of a variation of the zoom of the imaging optical unit 11. In any case, however, the observation pupil (not shown) is variable in diameter in order to stabilize or suitably limit the étendue in an intermediate image (not shown). Should this observation pupil (not shown) projected on the light exit surface 06 (shown in FIG. 1) of the illumination unit (shown in FIG. 1) be smaller than the light exit surface 06 (shown in FIG. 1), those of the LEDs 02 (shown in FIG. 1) whose assigned light mixing rods 01 (shown in FIG. 1) are impinged by the observation pupil (not shown) on their bottom bases 03 (shown in FIG. 1) are not operated and the remaining LEDs 02 (shown in FIG. 1) are operated. As a result, internal dark-field illumination can be realized, or internal ring illumination in the case of only partial correspondence of illumination patterns with the observation pupil (not shown). By contrast, coaxial bright-field reflected light illumination is obtained should those of the LEDs 02 (shown in FIG. 1) whose assigned light mixing rods 01 (shown in FIG. 1) are impinged by the zoom pupil (not shown) on their bottom bases 03 (shown in FIG. 1) be operated. The use of a zoom in this context should not be construed as limiting. It is also possible to use a fixed focal length tube lens without losing the described illumination variants. Only a brightness redistribution between the LEDs 02 (shown in FIG. 1) is necessary to continually switch between the coaxial bright-field reflected light illumination and the dark-field or ring light illumination. In the solutions known from the prior art, ring light or dark-field illumination and coaxial reflected light illumination are realized by different light sources, whereby, however, problems arise when setting the associated integration time and also when performing a white balance if the intention is to switch continually. These problems do not occur in the solution according to the invention on account of the single light exit surface 06 (shown in FIG. 1) fed by the multiplicity of LEDs 02 (shown in FIG. 1). The operation of a selection of the LEDs 02 (shown in FIG. 1) means that an illumination aperture stop is not required, and so the microscope preferably does not have such an illumination aperture stop. The selection of the LEDs 02 (shown in FIG. 1) can also be implemented in the form of luminous hemispheres on the light exit surface 06 (shown in FIG. 1) or any other shapes or patterns. Alternatively, individual LEDs 02 (shown in FIG. 1) can also be selected and operated. The patterns are preferably again divided into bright and dark fields of the observation, depending on which of the bottom bases 03 (shown in FIG. 1) are impinged by the projected observation pupil (not shown). Thus, a wide range of illumination modes can be realized. At least one microscopic image is preferably recorded with the microscope in each of these modes. Different result images are preferably generated from the microscopic images by common pixel operations. The pixel operations preferably comprise averaging.

A segmentation of the illumination is preferably carried out should reflections occur, for which purpose a selection of the LEDs 02 (shown in FIG. 1) whose assigned light mixing rods 01 (shown in FIG. 1) form luminous segments on the light exit surface 06 (shown in FIG. 1) with their bottom bases 03 (shown in FIG. 1) are selected and operated. This can also create variations of these reflections, whereby these reflections can be eliminated within the scope of subsequent image processing.

FIG. 7 shows a further embodiment of the illumination unit according to the invention. This embodiment initially resembles the embodiment shown in FIG. 1. In contrast to the embodiment shown in FIG. 1, the light mixing rods 01 are formed together, monolithically with a base plate 18. In this respect, the light mixing rods 01 have no termination region 07 (shown in FIG. 1).

What is claimed is:

1. An illumination unit for an optical microscope, comprising the following components:
a multiplicity of individual light sources; and
a multiplicity of light mixing elements, each having the shape of a solid or hollow pyramidal frustum with a bottom base, a top base, a lateral face and an axis, with the individual light sources each being arranged above the top bases of the light mixing elements and with the bottom bases of the light mixing elements together forming a light exit surface of the illumination unit.

2. The illumination unit as claimed in claim 1, wherein the light mixing elements are each formed by a light mixing rod in the form of a solid pyramidal frustum or each formed by a hollow integrator in the form of a hollow pyramidal frustum.

3. The illumination unit as claimed in claim 1, wherein the bottom bases of the pyramidal frustum-shaped light mixing elements each have the external shape of a convex polygon, which is suitable for gap-free tessellation of the bottom bases.

4. The illumination unit as claimed in claim 3, wherein the bottom bases of the pyramidal frustum-shaped light mixing elements each have the external shape of an equilateral triangle, a square or a regular hexagon.

5. The illumination unit as claimed in claim 1, wherein the bottom bases of the pyramidal frustum-shaped light mixing elements completely fill the light exit surface of the illumination unit.

6. The illumination unit as claimed in claim 1, wherein the pyramidal frustum-shaped light mixing elements each have a termination region, in which the lateral faces are perpendicular to the axis, at their bottom bases.

7. The illumination unit as claimed in claim 1, wherein at least three of the bottom bases of the light mixing elements come into contact at one point on a central axis of the light exit surface, or wherein the bottom base of exactly one of the light mixing elements is situated centrally on a central axis of the light exit surface.

8. An optical microscope for examining a sample by microscopy, comprising the following components:
an imaging optical unit for imaging the sample; and
an illumination unit as claimed in claim 1 for illuminating the sample.

9. The optical microscope as claimed in claim 8, wherein said optical microscope comprises a beam splitter which divides the microscope beam path into an observation component beam path and an illumination component beam path, the light exit surface of the illumination unit being arranged in the illumination component beam path.

10. A method for using a microscope as claimed in claim 8, comprising the following steps:
determining a selection of the individual light sources according to a specified characteristic of illumination of the sample to be achieved by the illumination unit; and
operating the selected individual light sources to illuminate the sample according to the specified characteristic of the illumination.

11. The method as claimed in claim 10, wherein the selection of the individual light sources comprises those of the individual light sources whose assigned light mixing elements with their bottom bases in a radial direction are located in an observation pupil of the microscope to illuminate the sample with a coaxial bright-field reflected light illumination.

12. The method as claimed in claim 10, wherein the selection of the individual light sources comprises those of the individual light sources whose assigned light mixing elements with their bottom bases in a radial direction are located outside of an observation pupil of the microscope to illuminate the sample with a coaxial dark-field illumination.
